(19) United States
(12) Patent Application Publication
(10) Pub. No.: US 2024/0216826 A1
(43) Pub. Date: Jul. 4, 2024

(54) TOY

(71) Applicant: BANDAI CO., LTD., Tokyo (JP)

(72) Inventors: Yoko MITSUISHI, Tokyo (JP); Yoshihiro MURAKAMI, Tokyo (JP)

(21) Appl. No.: 18/555,528

(22) PCT Filed: Apr. 6, 2022
(86) PCT No.: PCT/JP2022/017211

§ 371 Date: Oct. 15, 2023

(30) Foreign Application Priority Data
Jun. 25, 2021 (JP) 2021-105621

(51) Int. Cl. A63H 33/00; A63H 3/50

(52) U.S. Cl. CPC A63H 33/003; A63H 3/50

(57) ABSTRACT

Provided herein is a toy having a high attractiveness. The toy be transformed into a first form where the toy can be supplied from an article supply device, and a second form where an object can be displayed, and comprises a main part in a spherical shape. A first flat portion is formed on a first portion of an outer surface of the main part, and a second flat portion is formed on a second portion thereof, which is different from the first portion. Since the first flat face portion and the second flat face portion is formed as a flat part on an outer surface, the main part can be stably placed on a placing face when the main part is used in a display form (the second form).

### TECHNICAL FIELD

The present invention relates to a toy.

### BACKGROUND

Conventionally, there are capsule toys sold by a vending machine in each of which a doll etc. is included. For example, in Patent Document 1, parts to be assembled are contained in such a capsule composed of capsule constituent members. A predetermined number of cutouts are formed in a cut part of each of the capsule constituent members, and some of or all of the parts are respectively inserted in the cutouts thereby completing a toy. In addition, it is disclosed therein that ribs for holding the cut part of the capsule constituent member are formed on an inner wall of the capsule constituent member in order to prevent the capsule from dropping.

### PRIOR ART

### Patent Documents

[Patent Document 1] Japanese Patent Application Publication No. H07-148358

### SUMMARY

### Technical Problem

Patent Document 1 discloses a configuration in which a capsule itself is used as parts of the toy. However, a form in use of the capsule at time when the capsule is used as a part of the toy, is spherical as in the time of sale, so that the shape of the toy depends on the spherical shape of the capsule. Therefore, it is difficult to maintain the original impression of a character. Regarding a certain character, the shape thereof changes because of the capsule shape, thereby causing a quality problem of the character itself whereby amusement property thereof cannot be maintained. In addition, since the overall appearance of the toy itself is spherical as a basic form, there is a problem that the toy is unstable in a displayed state or a placed state and lacks the stableness.

It is an object of the present invention to provide a toy with stableness and high amusement property, which is capable of enhancing an impression of the character in a displayed state and easy to display.

### Solution to Problem

One of the aspects of the present invention is a toy capable of a change between a first form where the toy can be supplied from an article supply device, and a second form where an object can be displayed, the toy comprising a main part in a spherical shape, wherein a first flat portion is formed on a first portion of an outer surface, and a second flat portion is formed on a second portion which is different from the first portion.

### Advantageous Effect of Invention

It is possible to provide a toy with a high amusement property.

### BRIEF DESCRIPTION OF DRAWINGS

FIG. 1 is a front view of a toy according to an embodiment of the present invention in a first form;

FIG. 2 is a top perspective view of the toy in the first form shown in FIG. 1;

FIG. 3 is a perspective view thereof, showing an attaching structure for a first subpart shown in FIG. 1;

FIG. 4 is a perspective view of the first subpart, showing an inter face thereof;

FIG. 5 is a perspective view of an attaching structure for a second subpart shown in FIG. 1;

FIG. 6 is an exploded perspective view of a main part shown in FIG. 1;

FIG. 7 is a perspective view for illustrating attachment of a figure in a displayed state;

FIG. 8 is a perspective view for illustrating attachment of a third subpart in a display state;

FIG. 9 is a perspective view showing an example of the toy in a second form;

FIG. 10 is a perspective view of another example of the toy in the second form;

FIG. 11 is a perspective view of an example of the toy in a third form;

FIG. 12 is a perspective view of another example of the toy in the third form; and

FIG. 13 is an enlarged perspective view showing a state of formation of a pattern.

### DETAILED DESCRIPTION

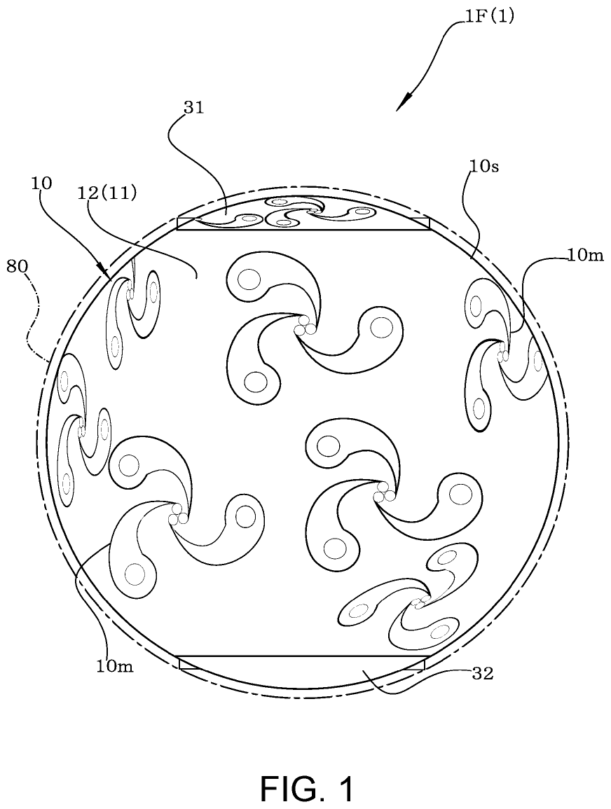

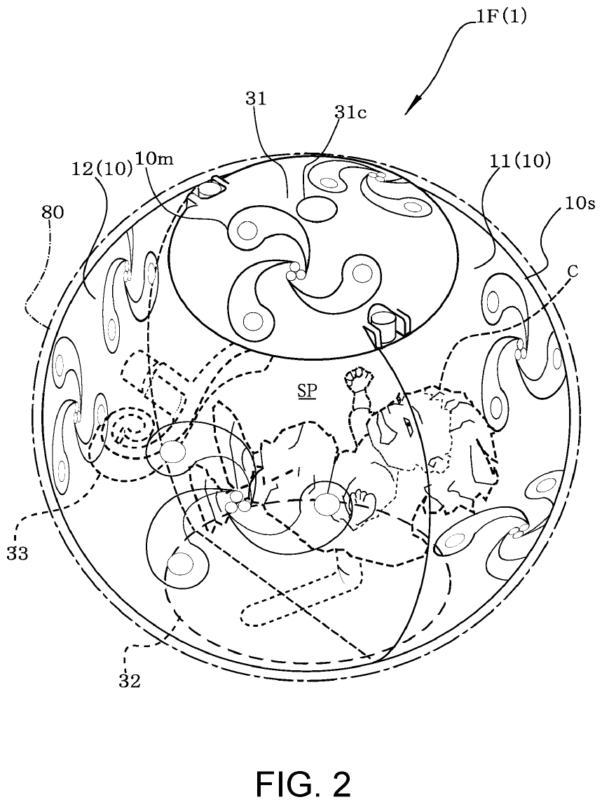

A toy according embodiments of the present invention will be explained, referring to FIGS. 1-13. FIG. 1 is a front view of a toy in a first form 1F. FIG. 2 is a top perspective view of the toy 1 in the first form 1F shown in FIG. 1.

As shown in FIGS. 1 and 2, the toy 1 in the first form 1F has a main part 10 which is made up of a first outer shell component 11 and a second outer shell component 12, and an external appearance thereof is approximately spherical. In the first form 1F, a first subpart 31 is attached to an upper part thereof, and a second subpart 32 is attached to a lower part thereof. The outer surface 10s of the toy is composed of the first outer shell component 11, the second outer shell component 12, the first subpart 31 and the second subpart 32. A wrapping film 80 is formed thereon so as to lap the outer surface 10s. Thus, the toy is not provided (sold) at a store. Since the toy 1 in the first form 1F is formed in a spherical shape so that the toy itself easily rolls, the toy can be supplied from an article supply device. The article supply device comprises an accommodation unit capable of accommodating a plurality of toys 1 in a non-aligned state, a control unit which can control the toys 1 to be supplied one by one from the accommodation unit on condition of payment of consideration, and a communication path which is connected to a supply port from the accommodation unit. Although the toy is made up of a plurality of parts so that it is easy to separate them from one another, since the toy 1 is formed in a shape by which the toy easily rolls, it is possible to supply the toy 1 to a user without breaking-up or damaging the toy 1 when the toy is supplied from the article supply device.

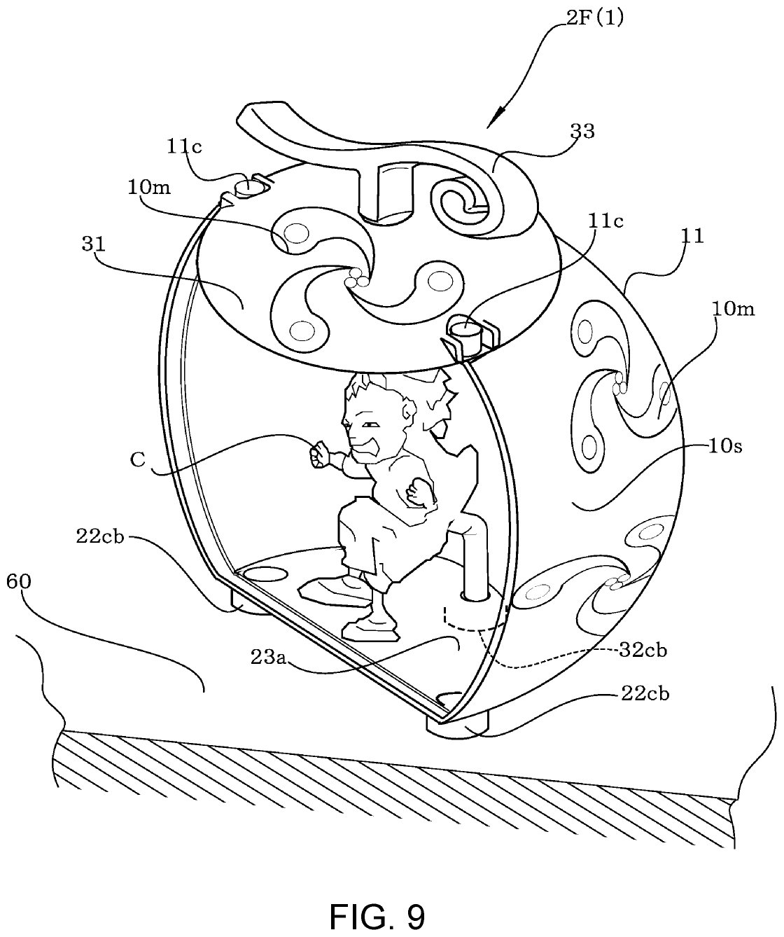

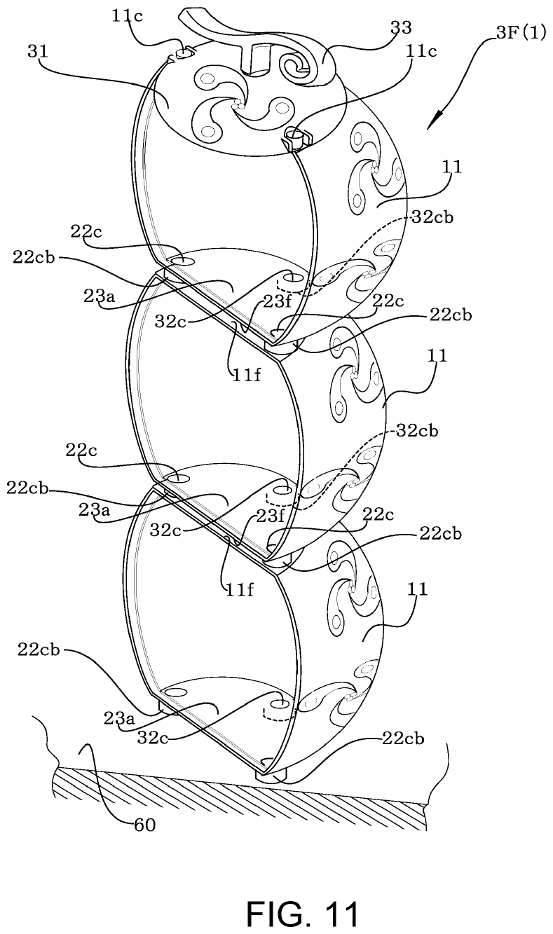

Further, a pattern 10m is formed on the outer surface 10s, and a space SP is formed thereinside so that a character C etc., which is an object described later, can be accommodated therein. In addition, the wrapping film 80 can be removed from the toy 1 and the toy can be taken apart so that the content therein can be taken out. Then, an assembly can be made by using the character C, so that the toy can be changed to the second form 2F (refer to FIG. 9) and the third form 3F (refer to FIG. 11).

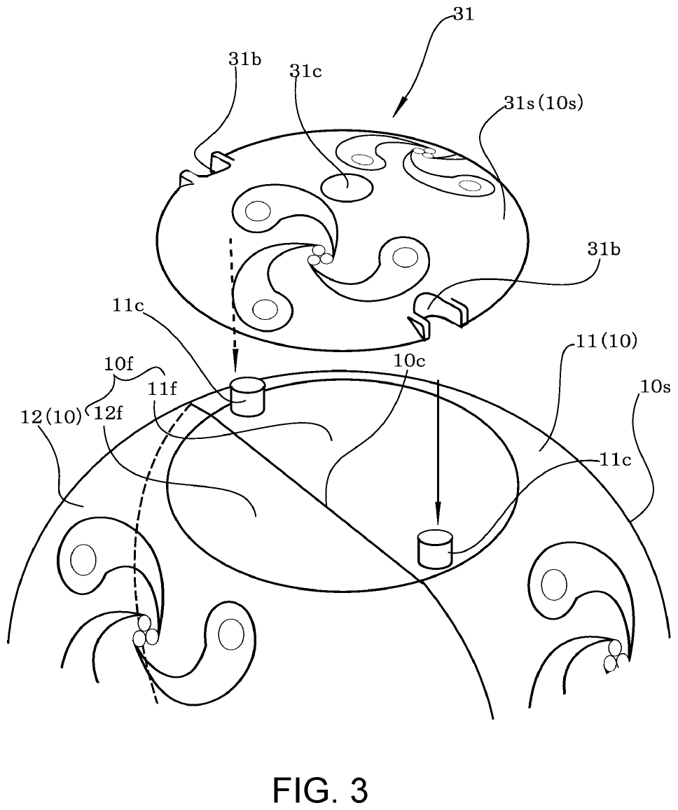

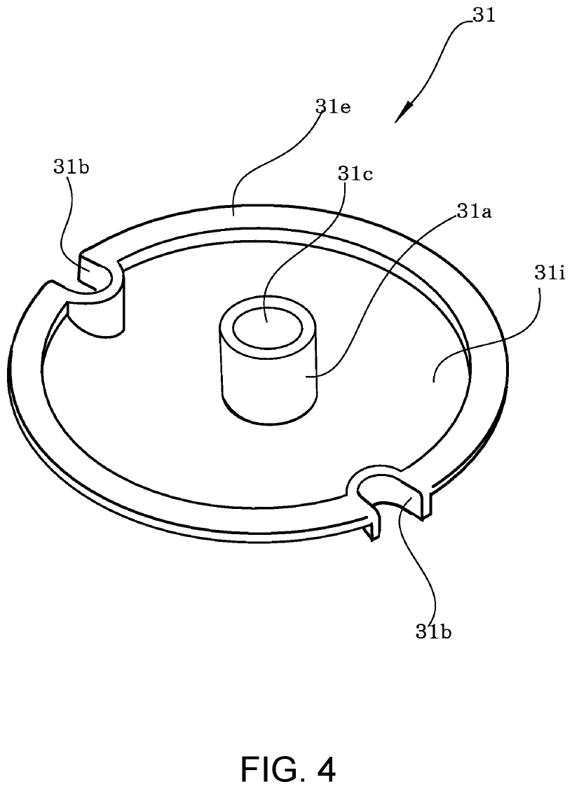

FIG. 3 is a perspective view of an attaching structure for the first subpart 31, and FIG. 4 is a perspective view of the first subpart, showing an inter face thereof. As shown in FIG. 3, a first flat portion 10f is formed on a first portion, which is an upper part of the main part 10, and the approximately disc-shaped first subpart 31 is attached to the first flat portion 10f. The first flat portion 10f is configured so as to be divided into the first outer shell 11 and the second outer shell 12 along a join line 10c. That is, the first flat portion 10f has a flat face on which the first apportion portion 11f formed on a side of the first outer shell component 11 and a second apportion portion 12f formed on a side of the second outer shell component 12 are apportioned. Further, the first outer shell component 11 is formed so as to be larger than the second outer shell component 12, and the size (area) of the first apportion portion 11f is also larger than the size (area) of the second apportion portion 12f. Furthermore, a pair of cylindrical connecting parts 11c is formed at a position adjacent to the join line 10c, on a side of the first apportion portion 11f.

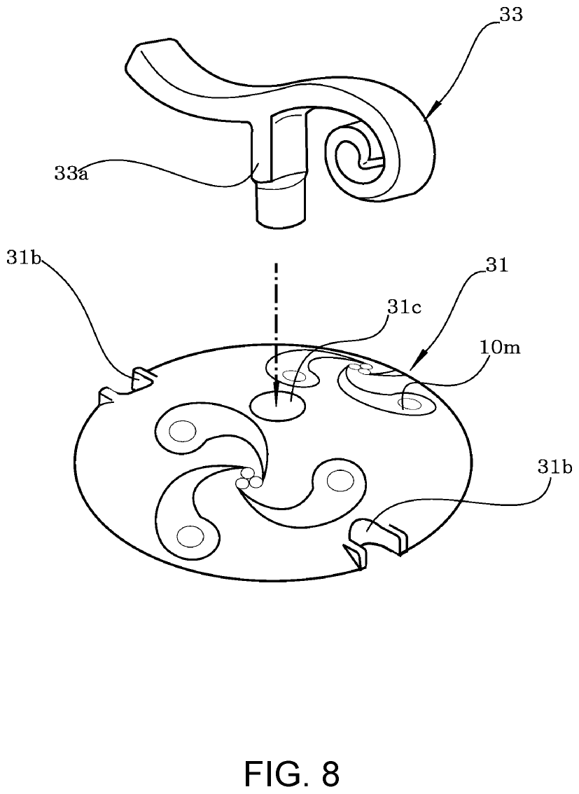

As shown in FIG. 3, an outer surface 31s of the first subpart 31 is formed as a curved face, which is part of the spherical surface (the outer surface 10s), and the pattern 10m is formed thereon. In addition, a pair of attachment cutouts 31b is formed at an outer peripheral edge of the first subpart 31, and an insert hole 31c to which a third subpart 33 (refer to FIG. 8) is attached, is formed at center thereof.

On the other hand, as show in FIG. 4, an inner face 31i of the first subpart 31 is formed to match with the first flat portion 10f. That is, a flat annular flat portion 31e having a predetermined width, which is different from the curved surface of the inner face 31i, is formed along the inner peripheral edge thereof. Further, a boss section 31a, at a center of which the insert hole 31c is formed, is arranged to protrude therefrom so that the height thereof is the same as that of the annular flat portion 31e. That is, in the first form 1F, the annular flat portion 31e and the boss section 31a of the first subpart 31 are in contact with the first flat face portion 10f, and the cutouts 31b are inserted in the pair of first connecting parts 11c in a fitting state and so that the first subpart 31 is connected to and cover the first flat portion 10f.

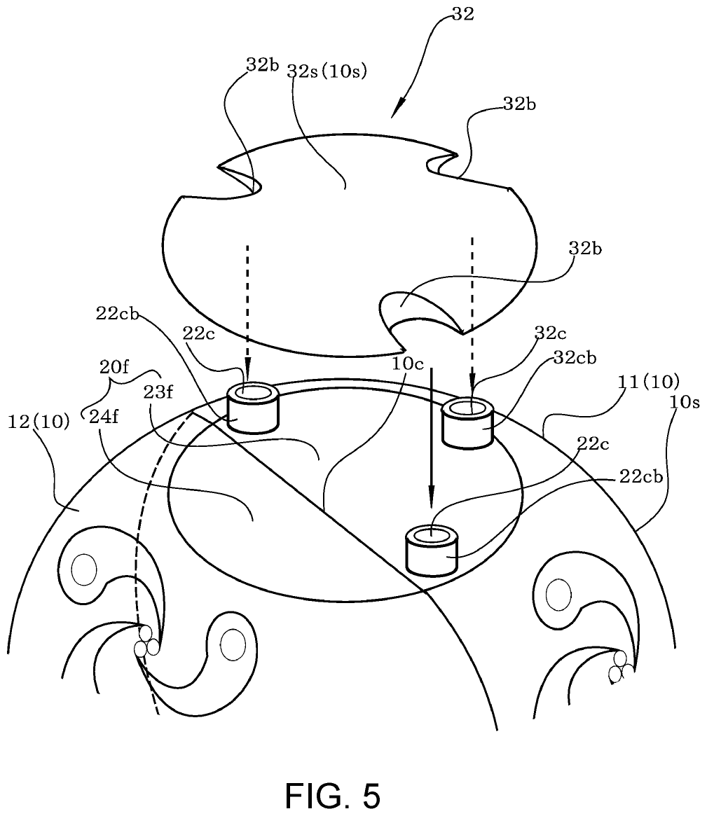

FIG. 5 is a perspective view of an attaching structure for the second subpart 32. As shown in FIG. 5, a second flat portion 20f is formed on a second part which is a lower portion of the main part 10, and the second subpart 32 is attached to the second flat face portion 20f. The second flat portion 20f is configured so as to be divided into the first outer shell 11 and the second outer shell 12 along a join line 10c. That is, the second flat face portion 20f is a flat face on which a third apportion portion 23f formed on a side of the first outer shell component 11 and a fourth apportion portion 24f formed on a side of the second outer shell component 12 are apportioned. The second flat face portion 20f is formed so that the size of the second flat face portion 20f is the same as that of the first flat face portion 10f. Further, the size (area) of the third apportion portion 23f is configured so as to be larger than the size (area) of the fourth apportion portion 24f.

An outer surface 32s of the first subpart 32 (an outer surface 10s) is formed as a curved face to form part of the spherical surface, and, similarly to the annular flat portion 31e of the first subpart 31, a flat face portion is formed on an inner face of the second subpart 32, so as to match with the second flat face portion 20f. In addition, three cutouts 32b are formed at an outer peripheral edge of the second subpart 32. Two of the three cutouts 32b engage with projection portions 22cb of a pair of second connecting parts 22c and the remaining one engages with an attachment hole projection 32cb in which an attachment hole 32c for attaching the character C is formed. That is, in the first form 1F, the second subpart 32 is held by engagement at the three portions thereby covering the second flat face portion 20f. Further, since the second subpart 32 is detached without being used in the second form 2F and the third form 3F, the pattern 10m is not formed thereon.

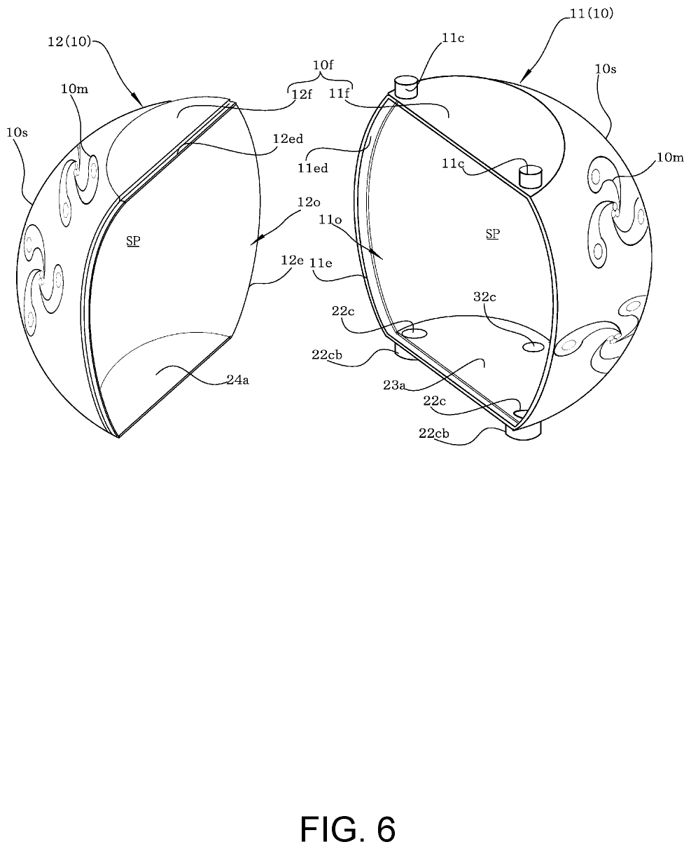

FIG. 6 is an exploded perspective view of the main part 10. The main part 10 is made up of the first outer shell component 11 and the second outer shell component 12, as described above. As shown in FIG. 6, both the first outer shell component 11 and the second outer shell component 12 are respectively formed in a hemispheric shape. For example, opening edges 11e and 12e which form respective openings 11o and 12o of the outer shell components 11 and 12 are configured so as to be connected to each other, so that the spherical space SP is formed inside the main part 10 in the first form 1F.

More specifically, an inner step part 11ed, which is configured as a thin part so that an inner side of the opening edge is recessed, is formed along the opening edge 11e of the first outer shell component 11. On the other hand, an outer step part 12ed is formed along an opening edge 12e of the second outer shell component 12, wherein the outer step part 12ed is configured as a thin part, which is recessed on an outer side of the opening edge. When the outer step part 12ed of the second outer shell component 12 is inserted in the inner step part 11ed of the first outer shell component 11, both the outer shell components 11 and 12 are connected to each other, thereby forming the space SP in the first form 1F.

Further, the bulge (depth) of the first outer shell component 11 and that of the second outer shell component 12 are different from each other, and the size of the first outer shell component 11 is larger than that of the second outer shell component 12.

The pair of cylindrical first connecting parts 11c formed on the first apportion portion 11f is configured in such a size that the first connecting parts can be respectively inserted in the second connecting parts 22c, which are round though-holes and formed in the third apportion portion 23f. The distance between the pair of first connecting parts 11c is configured so as to be the same as that between the second connecting parts 22c. Therefore, the first connecting parts 11c of the first outer shell component 11 can be inserted in and connected to the second connecting parts 22c of another first outer shell component 11. By this configuration, a plurality of first outer shell components 11 can be connected to each other, so that a display form (a third form 3F), which is different from a single configuration in the second form 2F, can be assembled.

The first outer shell component 11 and the second outer shell component 12 are made of, for example, synthetic resin as material thereof so as to have an appropriate stiffness property. The pattern 10m, which is drawn on the outer surface 10s, appropriately relates to the character C so that the pattern 10m evokes the character C. Further, the color of the outer shell components 11 and 12 is not limited specifically, but may be formed by light transmissive material.

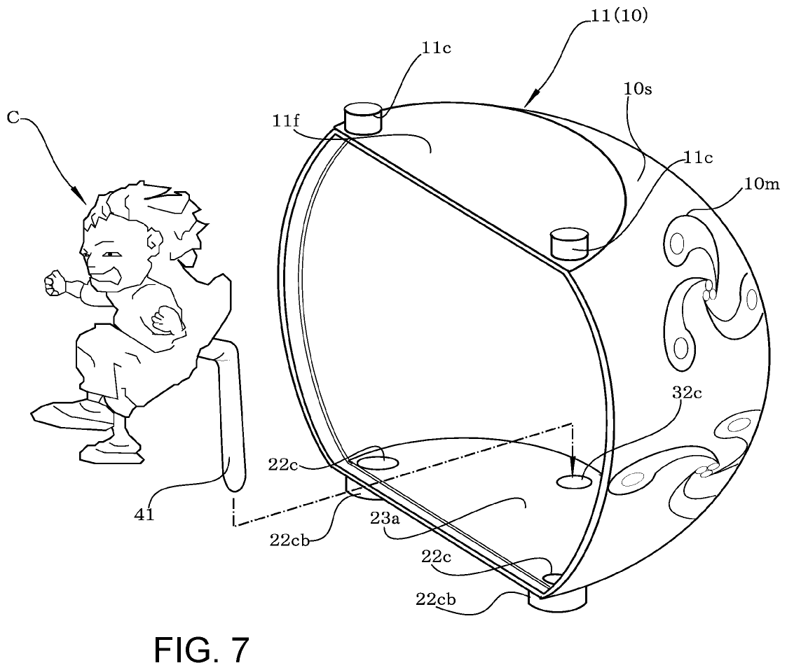

FIG. 7 is a perspective view for illustrating assembly of the character C in a displayed state. FIG. 8 is a perspective view for illustrating assembly of the third subpart 33 in the display state. As shown in FIG. 7, a holding rod 41, which extends downwardly (the same direction as that of leg portions), is formed on a back side of the body of the character C. On the other hand, an apportion flat portion 23a on an inner face side of the third apportion portion 23f of the first outer shell component 11 has an area capable of attaching the character C thereto, and an attachment hole 32c, in which the holding rod 41 can be inserted and fit, is formed therein. The character C is held on the apportion flat portion 23a in the second form 2F and the third form 3F. In addition, since projections 32cb for the attachment hole, which extend toward a side of the third apportion portion 23f (a lower side in the figure), are formed, a room for inserting the holding rod 41 is secured in a portion where the attachment hole 32c is formed.

As shown in FIG. 8, the third subpart 33 is formed in a shape imitating, for example, a stalk end of a fruit. For example, an axis part 33a, which is connected to a main body side of the fruit, is inserted in an insert hole 31c of the first subpart 31. The third subpart 33 decorates an upper part of the main part 10 in a displayed state (refer to FIG. 9) in which the main part 10 formed in the shape imitating such a fruit is displayed. A cross section shape of a leading end (to be inserted) of the axis part 33a is circular, so that the attachment orientation thereof may be set accordingly. However, it may be non-circular so that the orientation thereof may be predetermined. Further, since in the first form 1F, the first subpart 31 is covered and held by a wrapping film 80 (refer to FIG. 2), the third subpart 33 cannot be attached to the first subpart 31 and accommodated in the space SP.

FIG. 9 is a perspective view of an example in a second form 2F. In the displayed state shown in FIG. 9, a character C is displayed by using the first outer shell component 11, the first subpart 31 and the third subpart 33. In this case, similarly to the first form 1F, the first subpart 31 is attached and fixed to the connecting parts 11c of the first outer shell component 11. Further, since the three projection portions (the pair of projection portions 22cb and the attachment hole projection 32cb) are formed on a back side of the first outer shell component 11 in FIG. 9, the first outer shell component 11 can be stably placed on a placing face 60. In addition, according to the present embodiment, no pattern is formed on the inner face of the first outer shell component 11. However, when the outer shell component 11 is made of light transmitting material, the pattern 10m formed on the outer surface 10s can be seen from an inner side thereof due to the light transmission.

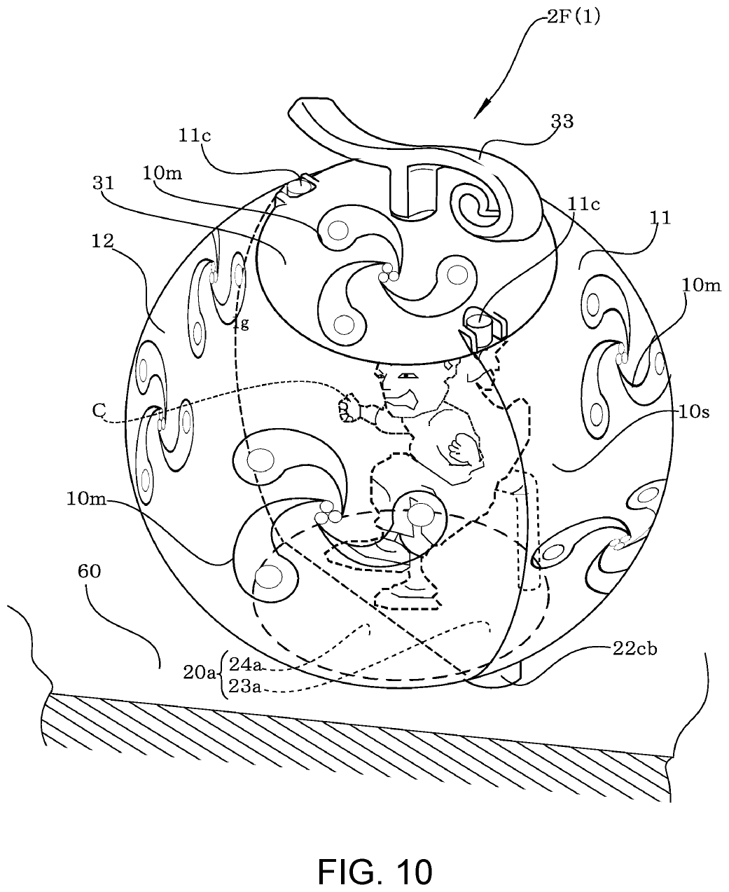

FIG. 10 is a perspective view of another example in the second form 2F. In the displayed state shown in FIG. 10, the character C is displayed in a closed sphere by using the first outer shell component 11, the second outer shell component 12, the first subpart 31 and the third subpart 33. In this case, the character C is fixed as in the case of FIG. 9, and the spherical fruit is formed by using all the components other than the second subpart 32.

In this case, a placing face for the character C is formed by a flat portion 20a having a large area (a portion on the inner side corresponding to the second flat portion 20f) wherein the flat portion 20a (a flat portion on an inner side thereof, corresponding to the second flat portion 20f) is formed by joining the apportion flat portion 23a of the first outer shell component 11 and an apportion flat portion 24a of the second outer shell component 12 to each other, so that it becomes possible to display a much larger character C. Further, specifically, the second outer shell component 12 is configured to have a good light transmittance, thereby effectively setting off the character C, which is placed within the pattern 10m drawn on the outer surface 10s in the display state.

FIG. 11 is a perspective view of an example in the third form 3F. FIG. 11 shows a first display state of the third form 3F as another example of the display form, in which three first outer shell components 11 are connected in a vertical direction. In the third form 3F, a third apportion portion 23f of one of the first outer shell components 11 which are vertically adjacent to each other, is connected to a first apportion portion 11f of the other first outer shell component 11 at a position where they face each other in one-to-one basis. Specifically, a pair of the first connecting parts 11c of the first outer shell component 11 located on a lower side thereof and a pair of the second connecting part 22c of the first outer shell component located on an upper side thereof are interlocked with each other. Further, an attachment hole projection 32cb of the first outer shell component 11 located on the upper side is in contact with the first apportion portion 11f of the first outer shell component 11 on the lower side, and the first apportion portion 11f of the first outer shell component 11 on the lower side thereof and the third apportion portion 23f of the first outer shell component 11 on the upper side thereof are vertically connected to each other in a line in a state where a gap is formed therebetween as shown in the figure. Further, the first subpart 31 in which the third subpart 33 is incorporated, can be attached to only the first apportion portion 11f which is located at the highest position thereamong. In this display state, a long, slender and high display form be formed.

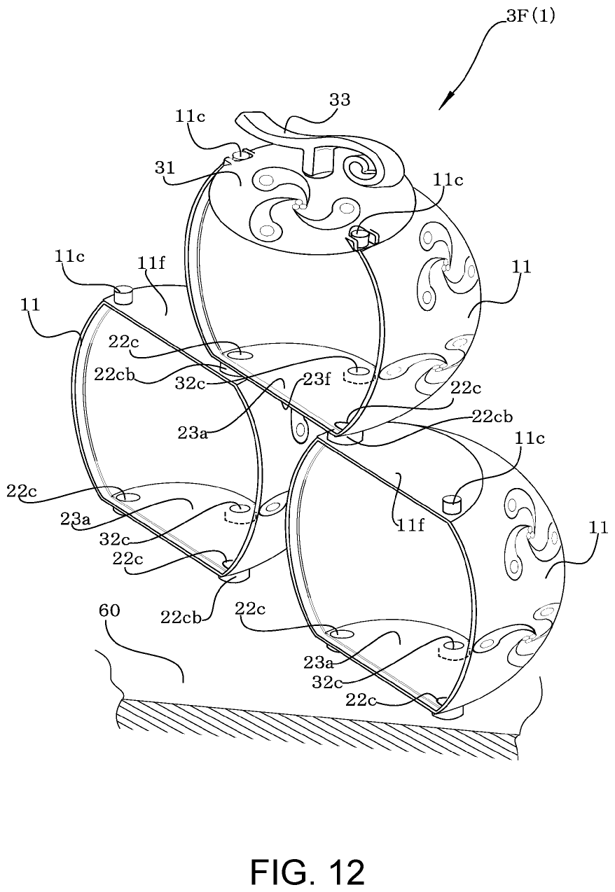

FIG. 12 is a perspective view of another example in the third form. FIG. 12 shows a second display state thereof as another example, wherein one first outer shell component 11 and two first outer shell components 11, to which the one first outer shell component 11 is attached, are connected to one another to form a pyramid shape (or a triangle shape) arrangement. In this display state of the third form 3F, the first apportion portions 11f of the two outer shell components 11 on the lower side are connected to the third apportion portion 23f of the one first outer shell component 11 on the upper side, so as to correspond to each other in a ratio of two to one. That is, this second display state is a connection state where one of the first connecting parts 11c of each of the two first outer shell components 11 is inserted in one of the second connecting parts 22c of the first outer shell component 11 on the upper side. Further, although the pyramid shape made of three pieces is shown in this figure, additionally three first outer shell components 11 may be connected below the two first outer shell components shown in the figure. In such case, the first subpart 31 in which the third subpart 33 is incorporated can be attached to only the first apportion portion 11f of the first outer shell component 11 which is located at the highest position. In this display form, a stable display state can be created.

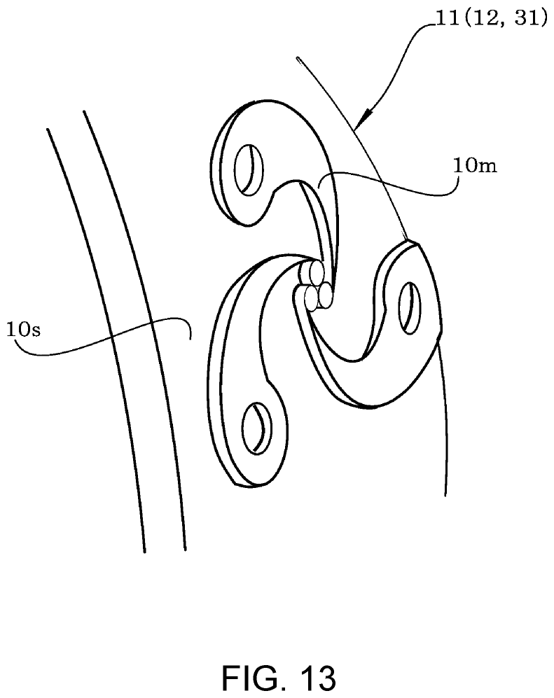

FIG. 13 is an enlarged perspective view of a formed pattern. The pattern 10m which is formed on the outer surface 10s of each of the first outer shell component 11, the second outer shell component 12, and the first subpart 31, may be drawn by printing. For example, as shown in FIG. 13, the entire pattern 10m may be shaped in a protruded form which rises from the outer surface 10s. Or differently from the protruded form, the outer surface 10s may be imprinted so that it may be in a concave form. Or the pattern 10s may be formed by using a groove form etc. in which a linear groove may be formed along the contoured part of the pattern 10m.

In the state where the pattern 10m is formed, when a concavity and convexity shape is formed on a surface of resin, if material of the first outer shell component 11 etc. is made of light transmissive resin, specifically, it is possible to bring about change in the pattern 10m by using transmittance of light and further refraction of light due to uneven part of the surface and the thickness thereof. Further, even when the pattern 10m is formed only on the outer surface 10s and a pattern is not directly drawn on a wall behind the character C, a subtle pattern performance becomes possible by a cooperation of a color pattern and an indirect performance which uses the thickness of the wall and light refraction (specifically, in case where the transparency thereof is high). Further, although the pattern 10m is formed on only the outer surface 10s in the figure, it may be formed on an inner surface side.

As described above, since the toy according to the present embodiment has a spherical appearance and the space SP can be formed thereinside, the character C or the third subpart 33 etc. can be accommodated in the main part 10 in the first form 1F, and the character C can be displayed inside thereof. Further, in the first form 1F, since the toy itself can roll, it can be automatically sold by a vending machine such as an article supply device etc. Since the main part 10 is made up of the approximately hemispherical first and second outer shell components 11 and 12, and an opening edge 11e of the openings 1o and the opening edge 12e of the opening 12o are configured so as to be connected to each other, it is easy to change each form, and also easy to take the character C in and out.

Since the first flat portion 10f and the second flat portion 20f are formed as flat parts on the outer surface 10s of the spherically shaped main part 10 of the toy 1 according to the present embodiment, when the main part 10 is used in a display form (the second form 2F or the third form 3F), it may be stably placed on a placing face. Further, it is possible to form the flat portion 20a on the inner side of the second flat portion 20f or the flat portion 23a on the inner side of the third apportion portion 23f, so that the character C can be easily placed and displayed thereon. Moreover, such flat parts are formed on a component having a spherical appearance, so that not only the connecting structure (bumps and dips or holes) can be easily formed but it is possible to provide and maintain stability of the connected state by the connection in which the flat parts face each other.

Further, in the first form 1F of the toy 1 according to the present embodiment, the first subpart 31 is connected to the main part 10 through the first connecting parts 11c, and the second subpart 32 is connected thereto through the second connecting parts 22c, so that differently from case where the subparts 31 and 32 are merely placed on a flat part, both the subparts 31 and 32 are certainly locked and fixed thereto, thereby maintaining the spherical shape thereof together with the main part 10, without using the wrapping film 80.

Further, in the second form 2F or the third form 3F, the first subpart 31 to which the third subpart 33 has been attached, can be connected to the first connecting part 11c located at least at the highest position, so that the first subpart 31 can be certainly fixed and held as a decorative component in the display form.

Further, since the first flat portion 10f is configured so as to have the same size as that of the second flat face portion 20f, and both the flat face portions 10f and 20f are respectively formed at upper and lower positions (180 degrees opposite sides), when the main part 10 is used as a display component containing the character C, it is possible to create a comfortable exhibition with a stable shape balance in the vertical and horizontal dimensions.

In the toy 1 according to the present embodiment, since the first outer shell component 11 is configured so as to be larger in size than that of the second outer shell component 2, when the first outer shell component 11 is used by itself in a display form, it is possible to expand the exhibition area and create an impressive presentation.

In the toy 1 according to the present embodiments, since the size of the first apportion portion 11f and the third apportion portion 23f of the first outer shell component is configured so as to be larger in size than that of the second apportion portion 12f and the fourth apportion portion 24f of the second outer shell component 12, when the first outer shell component 11 is used in a display form, the display area of the character C can be enlarged. In addition, when the first outer shell components 11 are connected to each other, it is possible to expand the flat portion and to ensure better connection and fixation.

Furthermore, in the toy 1 according to the present embodiments, since the second subpart 32 which can be attached to the second flat face portion 20f, is provided, the projection structure formed on the second flat face portion 20f can be covered thereby, and it is possible to make the overall shape of the toy 1 approximate a sphere.

Further, in the toy 1 according to the present embodiment, since the first connecting part 11c is provided at one end of the first outer shell component 11, and the second connecting part 22c is provided at the other end, and further, since both the connecting parts 11c and 22c are configured to be connectable to each other, it is possible to connect two or more main parts 10 (first outer shell components 11) with each other. Furthermore, since two or more connection points of both connecting parts 11c and 22c are configured to be aligned, a one-to-many (even more than two is possible) connection form becomes possible by individually connecting them at the connecting points. As a result, it becomes possible to enjoy variations in connection forms and achieve a wide range of presentation effects.

In the toy 1 according to the present embodiments, since a similar kind of pattern 10s is formed on the outer surface of each of the first outer shell components 11, the second outer shell component 12 and the first subpart 31, which form the outer surface 10s of the main part 10, it is possible to achieve a performance, using the pattern 10m in either the first form 1F (sales form) or the display form.

Furthermore, when the pattern 10m is formed on the inner surface of the first outer shell component 11, it is possible to set off the character C by using the pattern on the inner surface.

Further, in the case where the first outer shell component 11 and the second outer shell component 12 are made of light transmitting material, even when only the pattern 10m is formed on the outer surface 10s, the pattern 10m can be seen in the display form from the inside of the outer shell component. In addition, when the character C is displayed in the spherical shape, it is possible to show that the character C is within the pattern 10m of the first outer shell component 11 and the second outer shell component 12.

In addition, the toy 1 according to the present embodiments, in the case where the pattern 10m includes expression based on concave and convex on a resin surface, such as concaves, projections, groove(s), specifically, when the material of the first outer shell component 11 etc. is light transmissive resin, it is possible to introduce changes to the pattern 10m, by utilizing the refraction of light and variations in shading, thereby achieving diversification in the presentation of the pattern 10m and enhancing the exhibition effects of character C.

As described above, the embodiment of the present application is explained. However, the present invention may be modified if needed within the technical idea. For example, although the second connecting part 22c is a through hole in the above-described embodiments, the element is not limited thereto, and may be formed in a concave shape. Further, in the above-described embodiment, the attachment cutouts 31b is formed in a cutout shape, but is not limited thereto and may be an insertion hole. Moreover, the shape of the first flat face portion 10f and the second flat face portion 20f is configured so as to be approximately circular in the above-described embodiment. However, it may not necessarily be circular. For example, when the main part 10 is formed in an awkward spherical shape, they are formed in a shape which is not circular, accordingly.

### REFERENCE NUMERALS

1 Toy
1F First form
2F Second form
3F Third form
Main part
10f First flat face portion
10m Pattern
10s Outer surface
11 First outer shell component
11c First connecting part
11f First apportion portion
11o Opening of the first outer shell component
12 Second outer shell component
12f Second apportion portion
12o Flat portion
22c Second connecting part
20f Second flat face portion
23f Third apportion portion
23a Apportion flat portion
24f Fourth apportion portion
31 First subpart
32 Second subpart
33 Third subpart
60 Placing face
C Character (object)
SP Space

1. A toy capable of transforming into a first form where the toy can be supplied from an article supply device, and a second form where an object can be displayed, comprising:
a main part in a spherical shape,
wherein a first flat portion is formed on a first portion of an outer surface of the main part, and a second flat portion is formed on a second portion thereof, which is different from the first portion.

2. The toy according to claim 1, wherein the main part is configured so that the object can be accommodated therein in the first form and the second form.

3. The toy according to claim 1, wherein the first flat face portion is the same in size as that of the second flat face portion.

4. The toy according to claim 1, wherein the main part comprises a first outer shell component and a second outer shell component connectable to the first outer shell component, and the first outer shell component is larger in size than that of the second outer shell component.

5. The toy according to claim 4, wherein each of the first outer shell component and the second outer shell component has an opening portion and is in a hemispherical shape, and edge portions of the opening portions are configured so as to be connectable to each other.

6. The toy according to claim 5, wherein the first flat face portion is apportioned to the first outer shell component and the second outer shell component, and the size of the first apportion portion which forms the first flat face portion in the first outer shell component on one side thereof, is larger than that of the second apportion portion which forms the first flat face portion in the second outer shell component on the other side thereof.

7. The toy according to claim 6, wherein the second flat face portion is apported to the first outer shell component and the second outer shell component, and a size of a third apportion portion which forms the second flat face portion of the first outer shell component on one side thereof is larger than that of a fourth apportion portion which forms the second flat face portion of the second outer shell component on the other side.

8. The toy according to claim 7, wherein the first outer shell component is configured so that the object is displayable on an apportion flat portion on an inner face side thereof corresponding to the third apportion portion of the first outer shell component, in the second form in which the first outer shell component is separated from the second outer shell component.

9. The toy according to either claim 7, wherein the first outer shell component and the second outer shell component are configured so that the object is displayable on a flat portion of the second flat face portion on an inner face side corresponding to the second flat face portion formed on the first outer shell component and the second outer shell component, in the second form in which the edge portion of the opening portion of the first outer shell component and that of the second outer shell component are connected to each other.

10. The toy according to claim 7, further comprising a first subpart attachable to the first flat face portion and a second subpart attachable to the second flat face portion in the first form, wherein the second subpart is detached in the second form.

11. The toy according to claim 10, wherein a first connecting part is formed on the first apportion portion of the first outer shell component, and a second connecting part is formed on the third apportion portion thereof.

12. The toy according to claim 11, wherein the first connecting part is configured so as to be connectable to the second connecting part of the first outer shell component of another toy, and the toy is transformed into a third form in which the object can be displayed differently from that in the second form, by connecting the first connecting part and the second connecting part to each other.

13. The toy according to claim 12, wherein the third form includes a first display state in which the third apportion portion of one of the first outer shell components and the first apportion portion of another one of the first outer shell components correspond one-to-one with and connected to each other, and a second display state in which the third apportion portion of the one of the first outer shell components and the first apportion portions of two other first outer shell components correspond one-to-two with and connected to each other.

14. The toy according to claim 11, where in the first state, the first subpart is connected to the first outer shell component through the first connecting part, and the second subpart is connected to the first outer shell component through the second connecting part.

15. The toy according to claim 13, wherein the first subpart is configured so as to be attachable to only the first flat face portion or the first apportion portion, which is located at the highest position, in the third form.

16. The toy according to claim 10, further comprising a third subpart, wherein the first subpart is configured so that the third subpart is unattachable thereto in the first form, and the third subpart is attachable thereto in the second form.

17. The toy according to claim 16, wherein the main part has a shape imitating a fruit of a plant, and the third subpart has a shape imitating a stalk end of the plant.

18. The toy according to claim 10, wherein a same kind of pattern is formed on an outer surface of the first outer shell component, that of the second outer shell component, and that of the first subpart.

19. (canceled)

20. (canceled)

21. (canceled)

22. The toy according to claim 1, wherein the object is an article in shape of a character.
